(19) United States
(12) Patent Application Publication
(10) Pub. No.: US 2024/0322296 A1
(43) Pub. Date: Sep. 26, 2024

(54) BATTERY PACK AND CLEANER INCLUDING THE SAME

(71) Applicant: Samsung SDI Co., Ltd., Yongin-si (KR)

(72) Inventor: Sanghun PARK, Yongin-si (KR)

(21) Appl. No.: 18/607,668

(22) Filed: Mar. 18, 2024

(30) Foreign Application Priority Data
Mar. 26, 2023 (KR) 10-2023-0039353
Jul. 21, 2023 (KR) 10-2023-0095485

(51) Int. Cl. H01M 10/6566; H01M 10/613; H01M 10/623; H01M 10/6563; H01M 50/247

(52) U.S. Cl. CPC H01M 10/6566; H01M 10/613; H01M 10/623; H01M 10/6563; H01M 50/247; H01M 2220/30

(57) ABSTRACT

A battery pack includes an upper housing having one or more inlets on a first side and one or more outlets on a second side opposite to the first side, a lower housing below the upper housing, lower ribs on a bottom surface of the lower housing, the lower ribs being spaced apart from each other in a longitudinal direction of the lower housing, and battery cells on the bottom surface of the lower housing, the battery cells being supported by the lower ribs.

### CROSS-REFERENCE TO RELATED APPLICATION

The present application claims priority and the benefit of Korean Patent Application Nos. 10-2023-0039353, filed on Mar. 26, 2023, and 10-2023-0095485, filed on Jul. 21, 2023, in the Korean Intellectual Property Office, the entire disclosures of which are incorporated herein by reference.

### BACKGROUND

### 1. Field

One or more embodiments relate to a battery pack and a cleaner including the battery pack.

### 2. Description of the Related Art

As wireless electronic devices become widely used, capacities of battery packs used therein have gradually increased so as to increase the usable time of the wireless electronic devices. As battery packs with higher capacities and larger sizes have been developed, it is desirable to increase the cooling performance of the battery packs to ensure their reliability and safety.

### SUMMARY

According to one or more embodiments, a battery pack includes an upper housing having one or more inlets on one side and one or more outlets on another side opposite to the one or more inlets, a lower housing below the upper housing, and a plurality of lower ribs which each are formed on a bottom surface of the lower housing, support a plurality of battery cells, and are spaced apart from each other in a longitudinal direction of the lower housing.

The plurality of lower ribs may protrude from the bottom surface of the lower housing, and one battery cell may be seated between two neighboring lower ribs.

Each of the lower ribs may include a protruding section that is between two neighboring battery cells and protrudes from the bottom surface of the lower housing and a pair of inclined sections which respectively and curvedly extend from both sides of the protruding section and on which the battery cells are respectively seated.

A height of the protruding section may be about 10% to about 30% of a diameter of the battery cell.

The plurality of lower ribs may be spaced apart from each other in a width direction of the lower housing to form a plurality of rows, and overlap the battery cells.

The battery pack may further include one or more guides which are inside the upper housing to respectively correspond to the one or more inlets and extend downward to move air flowing in via the one or more inlets.

Each of the guides may include a guide entrance communicating with the inlet and a guide exit extending vertically from the guide entrance toward a curved front end of the lower housing.

The battery pack may further include a cell holder which is located in an inner space defined by the upper housing and the lower housing and supports an upper portion of each of the plurality of battery cells.

The cell holder may include a front end-protruding section in contact with the guide and a partitioning section which is located between two neighboring battery cells and extends downward.

A lower end of the front end-protruding section may be located below an exit of the guide.

A lower end of the partitioning section may be located below a center of the battery cell.

A lower end of the partitioning section may be spaced apart from an upper surface of the lower rib.

Each of the outlets may have a long hole shape extending in a width direction of the upper housing, and the battery pack may further include a plurality of upper ribs which are spaced apart from each other below the outlet and protrude from an inner surface of the upper housing toward an inner space of the battery pack.

The plurality of upper ribs may be inside the outlet and spaced apart from each other at different intervals.

According to one or more embodiments, a cleaner includes a main body, a suction hose at a front end of the main body, a motor inside the main body, a filter in front of the motor, and a battery pack located adjacent to the motor on one side of the main body, wherein, when the motor operates, air flowing in from the suction hose passes through the filter and part of the air flows into the battery pack, wherein the battery pack includes an upper housing having one or more inlets on one side and one or more outlets on another side opposite to the one or more inlets, a lower housing below the upper housing, and a plurality of lower ribs which each are formed on a bottom surface of the lower housing, support a plurality of battery cells, and are spaced apart from each other in a longitudinal direction of the lower housing.

### BRIEF DESCRIPTION OF THE DRAWINGS

Features will become apparent to those of skill in the art by describing in detail exemplary embodiments with reference to the attached drawings, in which:

FIG. 1 shows a schematic view of a cleaner including a battery pack, according to example embodiments;

FIG. 2 shows a schematic diagram of an air flow inside a cleaner, according to example embodiments;

FIG. 3 shows a perspective view of a battery pack, according to example embodiments;

FIG. 4 shows a cross-section of a battery pack, according to example embodiments;

FIG. 5 shows a bottom view of a lower housing of a battery pack, according to example embodiments;

FIG. 6 shows a cross-section of the lower housing and battery cells of a battery pack, according to example embodiments;

FIG. 7 shows an enlarged view of a portion of a battery pack, according to example embodiments;

FIG. 8 shows an enlarged view of an outlet of a battery pack, according to example embodiments; and

FIG. 9 shows an enlarged view of the outlet in FIG. 8.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

If an element or layer is referred to as being “connected” or “coupled” to another element or layer, the element or layer may be directly connected or coupled to another element or layer. Also, one or more elements or layers may additionally exist therebetween. If an element or layer is referred to as being “directly connected to” or “directly coupled to” another element or layer, there may be no other intervening elements or layers therebetween. For example, if a first element is described as being “coupled” or “connected” to a second element, the first element may be directly coupled or connected to the second element, or the first element may be indirectly coupled or connected to the second element via one or more intervening elements.

As used herein, the term “and/or” includes any and all combinations of one or more of the associated listed items. Also, the use of “may” in the description of embodiments of the present disclosure relates to “one or more embodiments of the present disclosure.” Expressions, such as “at least one” and “any one”, if preceding a list of elements, may modify the entire list of elements but not modify individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and other similar terms are used as terms of approximation and not as terms of degree, and these terms are utilized to account for inherent deviations in measured or calculated values that would be recognized by one of ordinary skill in the art.

Although terms such as first, second, third, etc. may be used herein to describe various elements, components, regions, layers, and/or sections, these elements, components, regions, layers, and/or sections are not limited by these terms. These terms are used to distinguish one element, component, region, layer, or section from another element, component, region, layer, or section. Therefore, a first element, first component, first region, a first layer, or first section described below may be referred to as a second element, a second component, a second region, a second layer, or a second section without departing from the disclosure of embodiments.

Spatially relative terms, such as “below,” “lower,” “above,” “upper,” etc. may be used herein for convenience of explanation to describe one element or feature's relationship to another element(s) or feature(s) illustrated in the drawings. The spatially relative terms may include other orientations of a device in use or operation in addition to the orientations depicted in the drawings. For example, if the device in the drawings is turned over, an element described as “below” or “under” another element or feature would then be oriented “above” another element or feature. Therefore, the term “below” may encompass both orientations of above and below. The device may be oriented in other directions (rotated 90 degrees or otherwise), and the spatially relative descriptors used herein should be interpreted with respect to those other directions.

In this specification, the terms are used only to explain embodiments of the present disclosure and not intended to limit the present disclosure. The singular forms used herein may include the plural forms as well, unless the context clearly indicates otherwise. The terms “comprise,” “provided with,” and “constitute,” when used in this specification, specify the presence of stated features, integers, steps, operations, elements, and/or components, but do not preclude the presence or addition of one or more other features, integers, steps, operations, elements, and/or components.

If embodiments may be implemented as processes, the order of specific processes may be performed differently from the described order. For example, two consecutively described processes may be performed simultaneously or substantially simultaneously or performed in an order reverse to the described order.

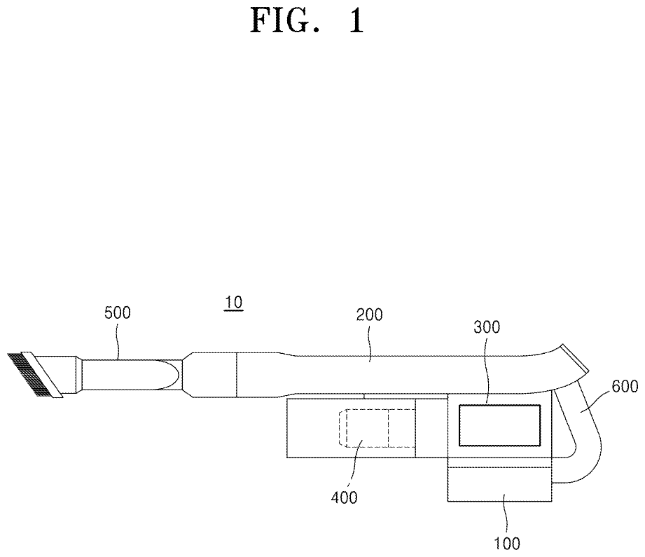

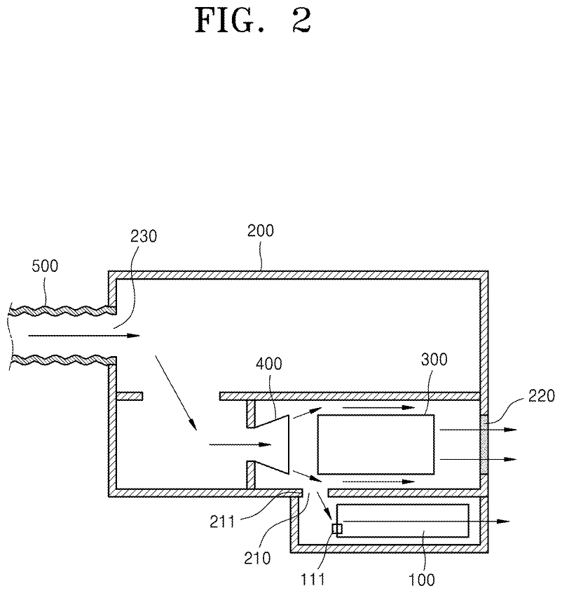

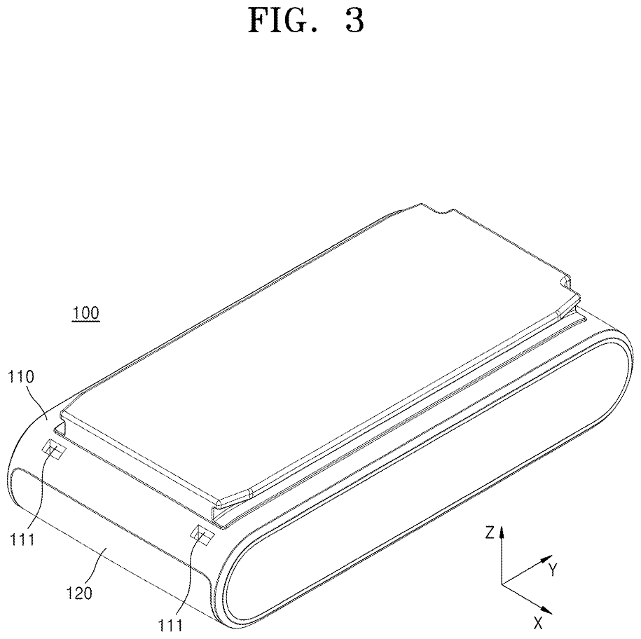

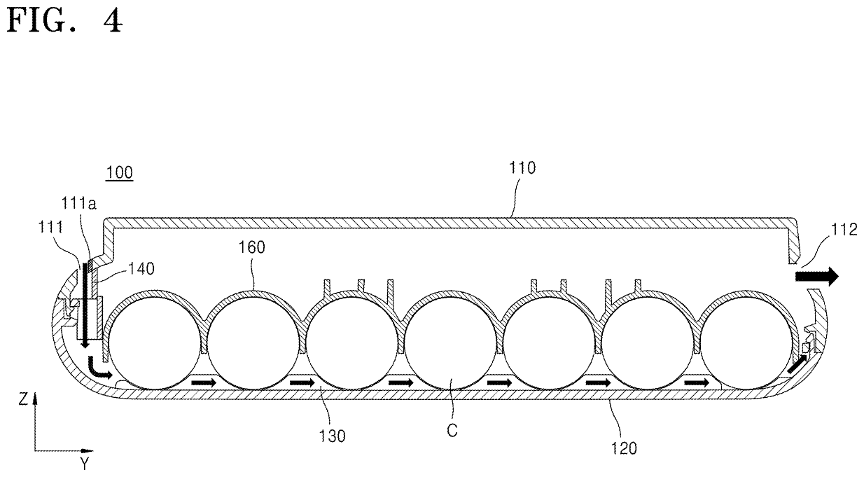

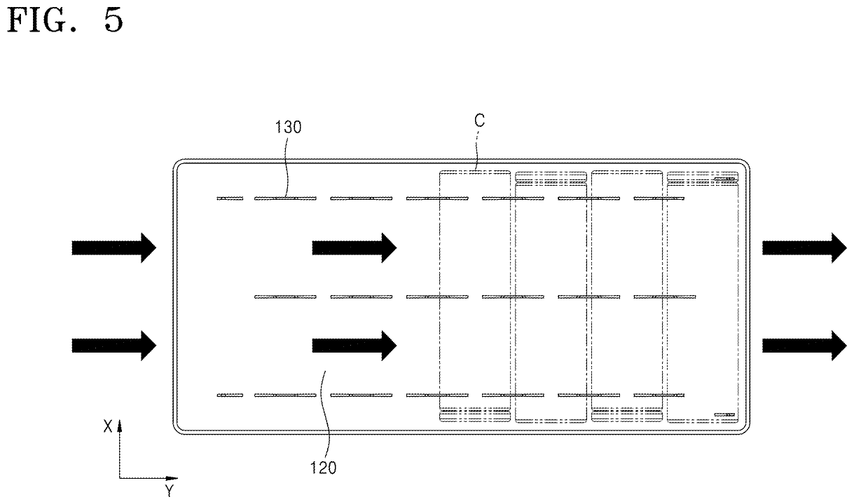

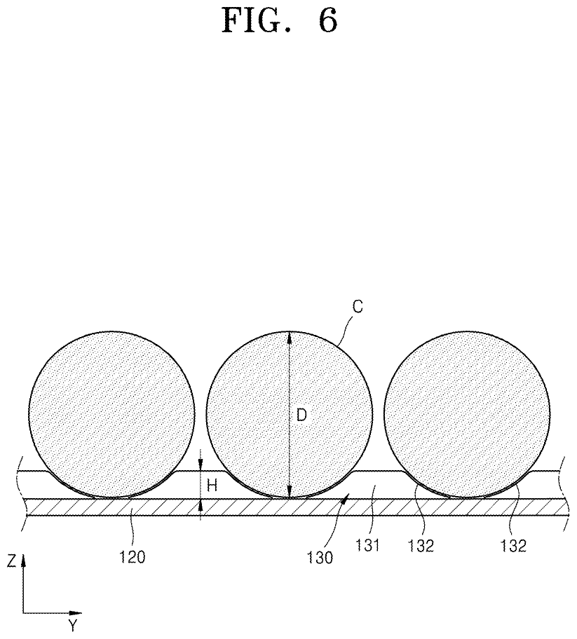

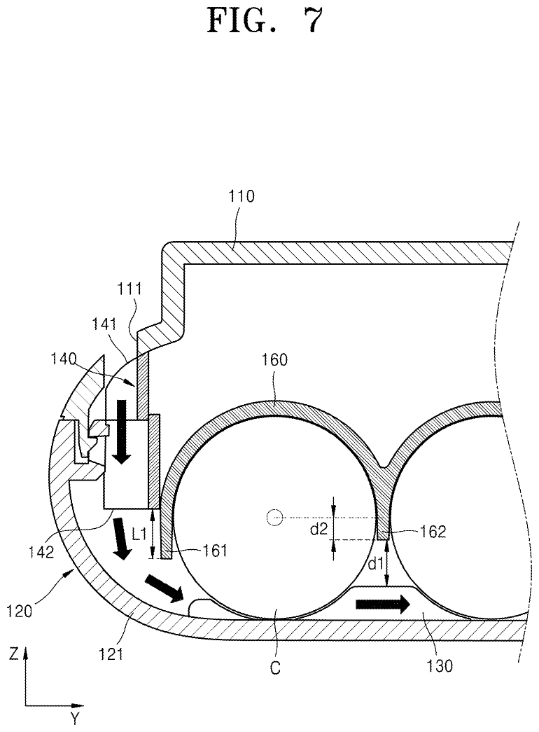

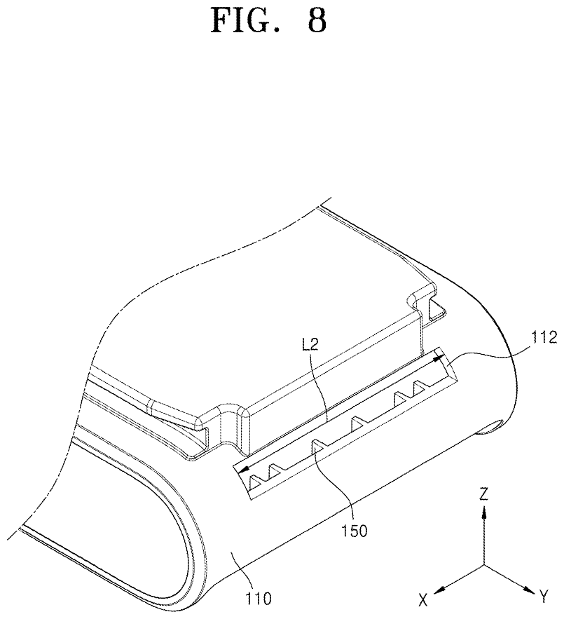

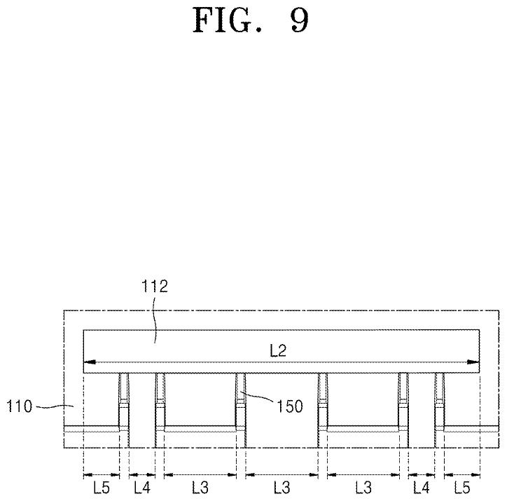

FIG. 1 shows a cleaner 10 including a battery pack 100, FIG. 2 shows an air flow inside the cleaner 10, FIG. 3 collectively shows the battery pack 100, FIG. 4 shows a cross-section of the battery pack 100, FIG. 5 shows a lower housing 120 of the battery pack 100, FIG. 6 shows a cross-section of the lower housing 120 and battery cells C of the battery pack 100, FIG. 7 shows an enlarged view of a portion of the battery pack 100, FIG. 8 shows an outlet 112 of the battery pack 100, and FIG. 9 shows an enlarged view of the outlet 112.

Referring to FIGS. 1 to 9, the battery pack 100 may be mounted on and used with the cleaner 10. The cleaner 10 may include, e.g., a cordless vacuum cleaner, and the battery pack 100 may be cooled using air drawn during an operation of the cleaner 10.

As illustrated in FIG. 1, the cleaner 10 may include the battery pack 100, a main body 200, a motor 300, a filter 400, a suction hose 500, and a handle 600. The battery pack 100 may be located on one side of the cleaner 10, e.g., at a lower end of the main body 200 adjacent to the motor 300, and supplies power to the cleaner 10.

In detail, as shown in FIGS. 1 and 2, the battery pack 100 may be located below (e.g., directly below) the motor 300, e.g., the battery pack 100 may be within a compartment attached directly to a lower surface of the main body 200 that is below the motor 300. Thus, the air drawn as the motor 300 operates may flow into the battery pack 100 more efficiently. If the cleaner 10 is placed on a charging stand to charge the battery pack 100, the battery pack 100 may be charged by receiving power from the charging stand.

As illustrated in FIGS. 3 and 4, the battery pack 100 may include an upper housing 110, a lower housing 120, a lower rib 130, a guide 140, and a cell holder 160. For example, the battery pack 100 may include the upper housing 110, which has one or more inlets 111 on one side (i.e., a first side) of the upper housing 110 and one or more outlets 112 on another side (i.e., a second side) of the upper housing 110 opposite to the one or more inlets 111, the lower housing 120, which is below the upper housing 110, and a plurality of lower ribs 130 formed on the bottom surface of the lower housing 120 and spaced apart from each other in the longitudinal direction of the lower housing 120 to support the plurality of battery cells C.

As shown in FIGS. 3 and 4, the upper housing 110 is located in an upper portion of the battery pack 100 and holds and supports other components of the battery pack 100 in conjunction with the lower housing 120. For example, the upper housing 110 may have a shape approximately similar to a rectangle or a cuboid, and the front and rear ends thereof may be curved. Also, in order to secure a space for the battery cells C and other components, the upper portion of the upper housing 110 may at least partially protrude upward.

One or more inlets 111 may be formed on one side of the upper housing 110. For example, as shown in FIGS. 3 and 4, two inlets 111 may be located on the front surface of the upper housing 110. Each of the inlets 111 may be positioned to correspond to (e.g., be in fluid communication with) a communication hole 210 of the main body 200 which is described below. Therefore, if the motor 300 operates, a portion of the inflowing air may flow into the battery pack 100 via the communication hole 210 and the inlet 111.

Each of the inlets 111 may include a sealing member 111a for airtightness. For example, as shown in FIGS. 4 and 7, the sealing members 111a having a ring shape may be located on the inner surfaces of the inlets 111 and may prevent air flowing from the communication hole 210 into the inlet 111 from leaking. Similarly, as shown in FIG. 2, a sealing member 211 corresponding to the communication hole 210 may be located on the inner surface of the communication hole 210. The sealing members 111a and 211 may include elastic materials, e.g., rubber.

The two inlets 111 may be spaced apart from each other. For example, as shown in FIG. 3, the two inlets 111 may be spaced apart from each other in a width direction of the upper housing 110 (an X-axis direction in FIG. 3). Also, the two inlets 111 may be spaced apart from the center of the upper housing 110 in the width direction of the upper housing 110. As described above, the plurality of inlets 111 are spaced apart from the center of the upper housing 110, and thus, the inflowing air may cool central portions of the plurality of battery cells C uniformly rather than locally.

For example, as illustrated in FIG. 3, the battery pack 100 may include two inlets 111 in the front. In another example, three or more inlets 111 may be spaced apart from each other in any suitable position in a height direction, e.g., the number of inlets 111 may vary depending on the size and specifications of the battery pack 100 and/or the number and arrangement of the battery cells C. Also, the inlet 111 may have a long hole shape in the X-axis direction.

The outlet 112 may be formed on another side of the upper housing 110, e.g., the inlet 111 and outlet 112 may be on opposite sides of the upper housing 110 along the Y-axis direction. As shown in FIG. 4, the outlet 112 may be formed at the rear of the upper housing 110 that is on the opposite side from the inlet 111. The air flowing in via the inlet 111 may cool the plurality of battery cells C while passing through the inside of the battery pack 100 and may be then discharged to the outside via the outlet 112.

For example, as shown in FIG. 8, the outlet 112 may have a long hole shape in the X-axis direction. Also, the outlet 112 may have an area greater than the sum of areas of the inlets 111, e.g., an area of the opening of a single outlet 112 may be larger than the sum of areas of openings of all the inlets 111. As described above, the outlet 112 may have a relatively large area compared to the inlets 111 and may be formed as a single hole, and thus, the inflowing air may be smoothly discharged via the outlet 112 without forming turbulence.

For example, a control module for controlling the battery pack 100 may be provided in the inner space of the upper housing 110 in addition to the plurality of battery cells C. The control module may include an electric circuit and various elements for preventing overcharge, overdischarge, an overcurrent, and a short-circuit of the battery cells C, and may measure and control charging states and temperatures of the battery cells C in real time.

As illustrated in FIGS. 3 and 4, the lower housing 120 may face the upper housing 110 and directly support the plurality of battery cells C. The lower housing 120 may have a shape similar to that of the upper housing 110, and the front and rear ends of the lower housing 120 may have curved shapes, as shown in FIGS. 3 and 4. The lower housing 120 may be inserted into and supported by a lower portion of the upper housing 110.

As shown in FIG. 7, a front end 121 of the lower housing 120 may face the guide 140 described below, and at least a portion of the front end 121 may have a convexly curved shape, e.g., the front end 121 may curve away from the bottom and from a lateral side of the upper housing 110. Therefore, the air discharged from the guide 140 may move along the inner surface (e.g., along the curved surface) of the front end 121 of the lower housing 120 and then cool the plurality of battery cells C while moving below the battery cells C. toward the outlet 112.

As shown in FIGS. 4 and 5, the plurality of battery cells C may include cylindrical cells located on the inner bottom surface of the lower housing 120. Each of the battery cells C may be positioned (e.g., lengthwise) in the width direction (the X-axis direction in FIG. 5) of the lower housing 120, and the battery cells C may be arranged side by side in the longitudinal direction (the Y-axis direction in FIG. 5) of the lower housing 120. Also, the plurality of battery cells C may be arranged while alternately changing directions of electrodes.

A plurality of lower ribs 130 may be provided on the bottom surface of the lower housing 120 to support the battery cells C and prevent vortices from occurring in the air flow while guiding the air flowing in via the inlets 111 toward the outlet 112. For example, as shown in FIGS. 4 and 5, the plurality of lower ribs 130 may be spaced apart from each other in the longitudinal direction (the Y-axis direction in FIG. 5) on the bottom surface of the lower housing 120. Also, the plurality of lower ribs 130 may be spaced apart from each other in the width direction (the X-axis direction in FIG. 5) to form a plurality of rows. For example, referring to FIGS. 4 and 5, since the plurality of lower ribs 130 may be arranged in a matrix pattern directly on the bottom surface of the lower housing 120 to support the battery cells C, spaces between the plurality of lower ribs 130 in both the X-axis and Y-axis directions (FIG. 5) may define a space between the bottom surface of the lower housing 120 and the battery cells C for air flow (e.g., arrows in FIG. 5). Therefore, the lower ribs 130 may support the battery cells C and, at the same time, serve as a guide for the air flow while extending in a direction in which the air moves. Thus, the air flowing in via the inlets 111 may move smoothly toward the outlet 112 without fluctuating inside the battery pack 100. Also, the lower ribs 130 may increase cooling efficiency by forming an air flow path to prevent air flowing to the bottom surfaces of the battery cells C from escaping to the outside of the battery cells C as much as possible.

For example, as illustrated in FIG. 4, the plurality of lower ribs 130 may protrude from the bottom surface of the lower housing 120 to a certain height into an interior of the lower housing 120, and one battery cell C may be seated between two neighboring lower ribs 130. For example, as illustrated in FIGS. 4 and 5, one battery cell C may be positioned to vertically overlap two neighboring lower ribs 130 and a space therebetween, so a portion of the battery cell C may be in the space between the two neighboring lower ribs 130.

For example, the plurality of lower ribs 130 may be arranged (e.g., extend lengthwise and be spaced apart) in one direction (e.g., in the Y-axis direction or the longitudinal direction of the battery pack 100) to form one row of the lower ribs 130. For example, as illustrated in FIG. 5, three rows of the plurality of lower ribs 130 may be arranged to be spaced apart from each other in another direction (e.g., in the X-axis direction or the width direction of the battery pack 100). In another example, two or four or more rows of the lower ribs 130 may be arranged. Also, distances between the lower ribs 130 in the Y-axis direction may be selected depending on the size of the battery cell C or the battery pack 100.

The lower ribs 130 may overlap (e.g., along the Z-axis direction) the battery cells C. For example, as shown in FIG. 5, the plurality of lower ribs 130 may be arranged in the X-axis direction inside the battery cells C.

One battery cell C may be seated between two neighboring lower ribs 130. As shown in FIG. 4, the lower ribs 130 may be spaced apart from each other in the Y-axis direction, and one battery cell C may be located in a space between two neighboring lower ribs 130. Also, a battery cell C may be spaced apart from another battery cell C while seated on the lower ribs 130. The cell holder 160 described below may be located in (e.g., may overlap in the Z-axis direction) a space between the battery cells C.

As shown in FIG. 6, the lower rib 130 may include a protruding section 131 and an inclined section 132. For example, the lower rib 130 may include the protruding section 131, which is between two neighboring battery cells C and protrudes from the bottom surface of the lower housing 120, and a pair of inclined sections 132, which respectively and curvedly extend from opposite sides of the protruding section 131 and on which the battery cells C are respectively seated.

For example, as illustrated in FIG. 6, the protruding section 131 may have a linear shape, and may protrude from the bottom surface of the lower housing 120 in the height direction. The protruding section 131 may have a flat upper surface, i.e., a surface facing away from the bottom of the lower housing 120. Also, the protruding section 131 may be between two neighboring battery cells C. For example, a height H of the protruding section 131 (e.g., in the Z-axis direction) may be no more than half a diameter D of the battery cell C. In detail, the height H may be about 10% to about 30% of the diameter D. If the height H of the protruding section 131 is less than 10% of the diameter D, the lower rib 130 may have substantially no effect in guiding the flow of air. Also, if the height H exceeds 30% of the diameter D, air may collide with the protruding section 131 while moving and generate a vortex. The height H of the protruding section 131 and the diameter D of the battery cell C may satisfy the above range, and thus, the effect of the lower housing 120 for guiding the air and preventing a vortex from occurring in the air flow may be improved.

The inclined sections 132 may extend curvedly from the protruding section 131 at both sides. For example, the inclined sections 132 may extend convexly downwardly from the upper end of the protruding section 131 at opposite sides thereof toward the bottom of the lower housing 120, and the curvature of the inclined section 132 may correspond to (e.g., trace or be equal to) the curvature of the outer circumferential surface of the battery cell C. For example, the inclined sections 132 may be integral with the protruding section 131 to define a single and seamless unit. Also, one battery cell C may be seated between a pair of facing inclined sections 132 of respective adjacent lower ribs 130.

As illustrated in FIG. 4, the guide 140 may be located on one side of the upper housing 110 and move air, which has flowed in from the outside, to the inside of the battery pack 100. For example, as shown in FIGS. 4 and 7, the guide 140 may be positioned to correspond to the inlet 111 (e.g., to be aligned with an inner surface of the inlet 111). Referring to FIGS. 1, 2, and 4, air may flow from the suction hose 500, pass through the filter 400 and the motor 300, and flow in via the communication hole 210 into the inlet 111 of the battery pack 100. For example, one or more guides 140 may be inside the upper housing 110 to respectively correspond to one or more inlets 111 and extend downwardly to move the air that has flowed in via one or more inlets 111, e.g., one guide 140 may be positioned at each inlet 111 in a one-to-one correspondence.

The guide 140 may include a member having the shape of a round pipe or a square pipe, and may be provided in plurality so as to correspond to one or more inlets 111, e.g., each guide 140 may be a pipe in the upper housing 110 that is attached to a bottom of a corresponding inlet 111 (e.g., a width of the bottom of the inlet 111 may equal a width of a guide entrance 141 of the guide 140). Therefore, until discharged from the guide 140, the air flowing in via the inlets 111 may move toward the battery cells C without being dispersed to other spaces of the battery pack 100. For example, referring to FIG. 4, the guide 140 may block the upper portion of the upper housing 110 above the battery cells C, so air flowing in via the inlets 111 and the guides 140 may move toward the battery cells C without being dispersed in the upper portion of the upper housing 110.

As illustrated in FIG. 7, the guide 140 may include a guide entrance 141 in fluid communication with the inlet 111, and a guide exit 142 discharging the air from the guide 140 toward the battery cells C. The guide 140 may extend straight downwardly in the Z-axis direction from the guide entrance 141 toward the guide exit 142. The guide exit 142 may extend vertically from the guide entrance 141 toward the front end 121 that is a curved portion in the lower housing 120. For example, as illustrated in FIG. 7, the guide 140 may be in direct contact with an inner surface of the upper housing 110, and may extend vertically from the inlet 111 toward the lower housing 120 in the Z-axis direction to at least partially overlap the battery cells C in the horizontal direction (e.g., in the Y-axis direction). For example, as illustrated in FIG. 7, the outer surface of the guide exit 142 of the guide 140 may directly contact the outer surface of the cell holder 160.

The cross-sectional area of the guide 140 may increase from the guide entrance 141 toward the guide exit 142. For example, as illustrated in FIG. 7, the guide 140 may have a first portion with a constant cross-sectional area (e.g., a constant width in the Y-axis direction), and then uniformly extend to have a second portion with a constant cross-sectional area (e.g., constant width in the Y-axis direction) that is larger than that of the first portion. For example, the first and second portions of the guide 140 may be in fluid communication with each other and may be connected to each other at a specific position. In another example, the guide 140 may have a shape in which the cross-sectional area continuously and gradually increases downwardly, e.g., in a direction oriented from the guide entrance 141 toward the guide exit 143. This shape of the guide 140 (i.e., increasing width) may allow the air flowing in via the inlet 111 to be smoothly guided to the battery cells C.

Referring to FIGS. 3 and 8, an upper rib 150 may be provided on another side of the upper housing 110 and prevent vortices from occurring in the flow of air that is discharged after cooling the battery cells C, e.g., the upper rib 150 and the inlets 111 may be on opposite sides of the battery pack 100 along the Y-axis direction. For example, as shown in FIGS. 8 and 9, the upper rib 150 may be located at the rear end of the upper housing 110 so as to correspond to the outlet 112, e.g., the upper rib 150 may be in the outlet 112. A plurality of upper ribs 150 may be inside the upper housing 110 and at the lower end of the outlet 112, e.g., the plurality of upper ribs 150 may extend in the Y-axis direction in the outlet 112 and may be spaced apart from each other in the X-axis direction.

The plurality of upper ribs 150 may be arranged inside the outlet 112. For example, referring to FIGS. 8 and 9, the outlet 112 may have a length L2 (e.g., in the X-axis direction), and all of the plurality of upper ribs 150 may be arranged within the length L2.

Referring to FIG. 9, the distances between the plurality of upper ribs 150 may be different from each other. For example, a total of six upper ribs 150 may be provided as shown in FIG. 9. The distance between the four upper ribs 150 located at inner positions may be L3, the distance between the upper ribs 150 located at outer positions may be L4, and the distance between the upper rib 150 on the outermost side and the edge of the outlet 112 may be L5. For example, the distance L3 may be larger than each of the distances L4 and L5.

Referring to FIG. 4, the cell holder 160 may support the plurality of battery cells C between the upper housing 110 and the lower housing 120. As shown in FIG. 4, the cell holder 160 may be located above the battery cells C to support upper portions of the plurality of battery cells C. Also, the cell holder 160 may have a curved shape corresponding to an outer circumferential surface of each of the battery cells C so as to support the outer circumferential surface of each of the battery cells C. Therefore, the cell holder 160 may have an approximate wave shape. Also, the cell holder 160 may support the plurality of battery cells C so that the battery cells C do not deviate from designated positions thereof.

As shown in FIG. 7, the cell holder 160 may include a front end-protruding section 161 and a partitioning section 162. For example, the front end-protruding section 161 may be at outermost edges of the cell holder 160 (e.g., facing an exterior of the cell holder 160), and the partitioning section 162 may be an internal portion of the cell holder 160.

In detail, as illustrated in FIG. 7, the front end-protruding section 161 may be provided at the foremost end of the cell holder 160 in the longitudinal direction (the Y-axis direction). The front end-protruding section 161 may extend vertically (e.g., along the Z-axis direction) toward the front end 121 of the lower housing 120. The front end-protruding section 161 may correspond to the guide 140 (e.g., may be in direct contact with the guide 140) and allow the air flowing in via the guide 140 to move below the battery cells C. Therefore, the front end-protruding section 161 may be in contact with the guide 140.

A lower end of the front end-protruding section 161 may be spaced apart from the guide exit 142 by L1, e.g., a lowermost end of the front end-protruding section 161 may be spaced apart from the lowermost end of the guide exit 142 by a distance L1 along the Z-axis direction. As shown in FIG. 7, the lower end of the front end-protruding section 161 may be located lower than the guide exit 142 by L1, e.g., relative to the bottom of the lower housing 120. Thus, the air discharged from the guide exit 142 may move below the battery cells C along the outer surface of the front end-protruding section 161 and the front end 121 of the lower housing 120, e.g., since the contact between the guide exit 142 and the front end-protruding section 161 may block air from moving above the battery cells C.

The lower end of the front end-protruding section 161 may be located below the center of the battery cell C, e.g., relative to the bottom of the lower housing 120. Therefore, the air flowing in from the guide 140 may flow into a space between the lower end of the front end-protruding section 161, the front end 121 of the lower housing 120, and the lower ribs 130, and may move below the battery cells C.

As further illustrated in FIG. 7, the partitioning section 162 may be between two neighboring battery cells C. As shown in FIG. 7, the cell holder 160 may extend curvedly along the outer circumferential surfaces of the battery cells C from the front end-protruding section 161 and may include partitioning sections 162 extending vertically downward in spaces between adjacent ones of the battery cells C. The partitioning sections 162 may prevent the battery cells C from deviating from the designated positions thereof or colliding with adjacent battery cells C due to vibration or shock that may occur while the battery pack 100 or the cleaner 10 is operating.

The lower end of the partitioning section 162 may be spaced apart from the lower rib 130 by a distance d1, e.g., a lowermost end of the partitioning section 162 may be spaced apart along the Z-axis direction from the upper surface of the protruding section 131 of the lower rib 130 by the distance d1. The lower end of the partitioning section 162 may be spaced apart from the center of the battery cell C by d2, e.g., the lower end of the partitioning section 162 may be lower than the center of the battery cell C (relative to the bottom of the lower housing 120). Therefore, the partitioning section 162 may more stably support the battery cells C located on both sides of the partitioning section 162.

Referring back to FIG. 1, the main body 200 of the cleaner 10 may include circuits for controlling other components of the cleaner 10 and may be provided with buttons or displays for user operation. Also, the suction hose 500 for moving foreign substances (e.g., removing by suction) may be located at the front end of the main body 200, and a flow path, through which air moves together with the foreign substances, may be provided inside the main body 200. The foreign substances and air, which flow into the suction hose 500, may flow in via an entrance 230 formed on one side of the main body 200 and move to the filter 400 and the motor 300.

The motor 300 and the filter 400 may be located inside the main body 200, and the handle 600 for the user to hold may be located at the rear of the main body 200. The main body 200 may include the communication hole 210 and a discharge opening 220.

As shown in FIG. 2, the communication hole 210 may be formed on one side of the bottom surface of the main body 200, to which the battery pack 100 is mounted, and may be in fluid communication with the inlet 111 of the battery pack 100, which is described below. If the motor 300 operates, the inflowing air and foreign substances may pass through the filter 400 and move toward the motor 300. Also, part of the air may flow into the battery pack 100 via the communication hole 210 (arrows in FIG. 2). Also, the discharge opening 220 may be formed on one side of the rear portion of the main body 200, and the remaining air may be discharged to the outside of the cleaner 10 via the discharge opening 220. As described above, the sealing member 211 may be located inside the communication hole 210 to prevent leakage of the air that flows into the battery pack 100.

The main body 200 may include a housing surrounding the motor 300 and the filter 400. The motor 300 may operate by receiving power from the battery pack 100 and may draw air. As shown in FIG. 2, a negative pressure environment may be created inside the cleaner 10 as the motor 300 operates, and the air and foreign substances may flow in via the suction hose 500.

The motor 300 may be located inside the rear portion of the main body 200 and behind the filter 400. The motor 300 may be isolated from an internal circuit of the main body 200 or the like by partition walls.

If air and foreign substances flow in via the suction hose 500, the filter 400 may filter the foreign substances to prevent the foreign substances from entering the battery pack 100 and the motor 300. The filter 400 may be located in front of the motor 300 with respect to a direction in which the air flows. Some of the air filtered by the filter 400 may move to the battery pack 100 via the communication hole 210, and a remaining portion of the air may be discharged via the discharge opening 220.

The suction hose 500 may be located at the front end of the main body 200 and draw foreign substances together with air. Also, a user may operate the cleaner 10 by gripping the handle 600 located at the rear of the main body 200.

The battery pack 100 and the cleaner 10 may efficiently cool the battery pack 100 using the air flow that is generated by the operation of the cleaner 10. The battery pack 100 and the cleaner 10 may include the lower rib 130 and the upper rib 150, and thus, it may be possible to prevent vortices from occurring in the air that flows in the battery pack 100 and to allow the air to move smoothly. The battery pack 100 and the cleaner 10 may also include the guide 140 for guiding air flowing from the motor 300, below the battery cells C, and thus, it may be possible to efficiently cool the battery pack 100.

By way of summation and review, if battery packs are not cooled properly, temperatures of the battery packs increase during charging, which may deteriorate the charging capacities or cause damage and breakage of the battery packs. For example, immediately after a cordless vacuum cleaner is used, the temperature of a battery pack in the cordless vacuum cleaner is high. If the battery pack is charged in this state, the charging capacity decreases, and thus, the operating time of the cordless vacuum cleaner after charging decreases.

Attempts have been made to implement battery packs used in cordless vacuum cleaners with separate motors to increase their cooling performance. However, such battery packs may have complicated configurations and increased weights.

In contrast, one or more embodiments include a battery pack with efficient cooling and a cleaner including the battery pack. That is, the battery pack and the cleaner may efficiently cool the battery pack using the air flow that is generated by the operation of the cleaner. The battery pack and the cleaner may include the lower rib and the upper rib, and thus, it is possible to prevent vortices from occurring in the air that flows in the battery pack and to allow the air to move smoothly. The battery pack and the cleaner may include the guide for guiding the air, which has flowed in from the motor, below the battery cells, and thus, it is possible to efficiently cool the battery pack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
an upper housing having one or more inlets on a first side and one or more outlets on a second side opposite to the first side;
a lower housing below the upper housing;
lower ribs on a bottom surface of the lower housing, the lower ribs being spaced apart from each other in a longitudinal direction of the lower housing; and
battery cells on the bottom surface of the lower housing, the battery cells being supported by the lower ribs.

2. The battery pack as claimed in claim 1, wherein the lower ribs protrude from the bottom surface of the lower housing into an interior of the lower housing, each of the battery cells being between two neighboring ones of the lower ribs.

3. The battery pack as claimed in claim 1, wherein each of the lower ribs includes:
a protruding section between two neighboring ones of the battery cells, the protruding section protruding from the bottom surface of the lower housing; and
a pair of inclined sections at opposite sides of the protruding section, respectively, the pair of inclined sections curvedly extending toward the two neighboring ones of the battery cells, respectively.

4. The battery pack as claimed in claim 3, wherein a height of the protruding section is about 10% to about 30% of a diameter of each of the battery cells.

5. The battery pack as claimed in claim 1, wherein the lower ribs are spaced apart from each other in a width direction of the lower housing to define rows overlapping the battery cells.

6. The battery pack as claimed in claim 1, further comprising one or more guides inside the upper housing, the one or more guides being connected to a corresponding one of the one or more inlets and extending downwardly toward the lower housing.

7. The battery pack as claimed in claim 6, wherein each of the one or more guides includes:
a guide entrance in fluid communication with the corresponding one of the one or more inlets; and
a guide exit extending vertically from the guide entrance toward a curved front end of the lower housing.

8. The battery pack as claimed in claim 6, further comprising a cell holder in an inner space of the upper housing and the lower housing, the cell holder being configured to support an upper portion of each of the battery cells.

9. The battery pack as claimed in claim 8, wherein the cell holder includes:
a front end-protruding section in contact with the guide; and
a partitioning section between two neighboring ones of the battery cells and extending downwardly.

10. The battery pack as claimed in claim 9, wherein a lower end of the front end-protruding section is below a guide exit of the guide.

11. The battery pack as claimed in claim 9, wherein a lower end of the partitioning section is below a center of the battery cell.

12. The battery pack as claimed in claim 9, wherein a lower end of the partitioning section is spaced apart from an upper surface of a corresponding one of the lower ribs.

13. The battery pack as claimed in claim 1, further comprising upper ribs spaced apart from each other in each of the one or more outlets, the upper ribs protruding from an inner surface of the upper housing toward an inner space of the battery pack, and each of the one or more outlets having a long hole shape extending in a width direction of the upper housing.

14. The battery pack as claimed in claim 13, wherein the upper ribs are inside the one or more outlets and spaced apart from each other at different intervals.

15. A cleaner, comprising:
a main body;
a suction hose at a front end of the main body;
a motor inside the main body;
a filter in front of the motor; and
a battery pack adjacent to the motor on one side of the main body, the motor being configured to operate the suction hose and draw air through the filter into the battery pack, and the battery pack including:
an upper housing having one or more inlets on a first side and one or more outlets on a second side opposite to the first side,
a lower housing below the upper housing,
lower ribs on a bottom surface of the lower housing, the lower ribs being spaced apart from each other in a longitudinal direction of the lower housing, and
battery cells on the bottom surface of the lower housing, the battery cells being supported by the lower ribs.
